(19) United States
(12) Patent Application Publication
(10) Pub. No.: US 2022/0284704 A1
(43) Pub. Date: Sep. 8, 2022

(54) ANOMALY DETECTION METHOD AND SYSTEM FOR IMAGE SIGNAL PROCESSOR

(71) Applicant: Black Sesame Technologies Inc., San Jose, CA (US)

(72) Inventors: Zhijie Lei, Shanghai (CN); Zhiqiang Qiu, Shanghai (CN)

(21) Appl. No.: 17/686,168

(22) Filed: Mar. 3, 2022

(30) Foreign Application Priority Data
Mar. 4, 2021 (CN) 202110241971.5

(51) Int. Cl. G06V 10/98

(52) U.S. Cl. CPC G06V 10/98

(57) ABSTRACT

An anomaly detection method and system for image signal processor are disclosed. The anomaly detection method includes the followings. A test image following a predetermined image configuration rule is generated. The test image is provided to an image signal processor. The predetermined first image processing parameters for processing the test image are provided to the image signal processor. And the processed test images are detected to determine whether there are anomalies in the image signal processor. The processed test images are an images output after the image signal processor processes the test image based on the first image processing parameters.

### CROSS REFERENCE TO RELATED APPLICATION

This patent application claims the benefit and priority of Chinese Patent Application No. 202110241971.5 filed on Mar. 4, 2021, the disclosure of which is incorporated by reference herein in its entirety as part of the present application.

### TECHNICAL FIELD

The present disclosure relates to the technical field of chip functional security testing, and more specifically, to a method and system for detecting anomaly of image signal processor.

### BACKGROUND ART

Artificial intelligence (AI) vision based automatic driving technologies have been applied more and more widely with the development of automatic driving. image signal processor (ISP) plays an important role in system-on-chip (SOC). The ISP receives and processes signals from vehicle mounted cameras and outputs high-qualified images for subsequent AI vision systems. An important premise of the AI visual automatic driving technologies lies in whether the ISP can efficiently provide high-quality image information for a long time. Once the image signal processor is abnormal, the whole SOC will not function normally, which may lead to safety accidents in the process of automatic driving.

Currently, design for testability (DFT) logic is typically integrated into the chip during chip design, and then after the chips are manufactured, the non-problematic chips are selected by testing the chip with the DFT logic integrated in advance. However, the DFT technology fails to detect whether the chip is running normally in real time when the chip is being used, so it can not detect the functional security of the image signal processor in real time.

In the existing arts, parity or error checking and correction (parity/ECC) technology or redundancy design technology are typically used to detect errors in chips. However, the parity/ECC can only detect the errors of static random-access memory (SRAM), while the logic errors of the chip cannot be detected. Redundancy design requires more area resources and higher cost. Therefore, these two technologies are not suitable for real-time and effective monitoring of the functional safety of image signal processor.

Therefore, it is necessary to provide an anomaly detection technology for the image signal processor, so that the image signal processor can be monitored in real time and effectively without consuming too much resources.

### SUMMARY

In view of the above, the disclosure provides an anomaly detection method and system for the image signal processor, so that the image signal processor can be monitored in real time and effectively without consuming too much resources (e.g. area resources).

A first aspect of the disclosure is to provide a method for detecting anomaly of the image signal processor. The method includes the steps as follows. A test image is generated and the test image follows a predetermined image configuration rule. The test image is provided to an image signal processor. First image processing parameters for processing the test image is provided to the image signal processor. The first image processing parameters are predetermined. The processed test images are detected to determine whether there are anomalies in the image signal processor. The processed test images are images output after the image signal processor processes the test image based on the first image processing parameters.

A second aspect of the disclosure is to provide an anomaly detection system for the image signal processor, including a test image generation circuit, an image selection circuit, an image processing parameter selection circuit and an anomaly detection circuit. The test image generation circuit is configured to generate a test image, and the test image follows a predetermined image configuration rule. The image selection circuit is configured to receive a normal image and the test image generated by the test image generation circuit, and is configured to select to provide the normal image or the test image to the image signal processor. The image processing parameter selection circuit is configured to receive first image processing parameters for processing the test image and second image processing parameters for processing the normal image, and is configured to select to provide the first image processing parameters or the second image processing parameters to the image signal processor. The first image processing parameters are predetermined. The anomaly detection circuit is configured to receive the processed test images from the image signal processor, and is configured to detect the processed test images to determine whether there are anomalies in the image signal processor. The processed test images are images output by the image signal processor after processing the test image based on the first image processing parameters.

### BRIEF DESCRIPTION OF THE DRAWINGS

FIG. 1 is a flowchart of the method for detecting anomaly of an image signal processor according to an embodiment of the disclosure.

FIG. 2 is a structural block diagram of the anomaly detection system for an image signal processor according to an embodiment of the disclosure.

FIG. 3 is a schematic block diagram of the anomaly detection circuit according to an embodiment of the disclosure.

FIG. 4 is a block diagram of an application example of the parallel detection circuit in the anomaly detection system according to an embodiment of the disclosure.

### DETAILED DESCRIPTION OF THE EMBODIMENTS

In order that the above objects, features and advantages of the disclosure be more clearly understood, a detailed description of the embodiments of the present invention will be made with reference to the accompanying drawings. In the following description, numerous specific details are set forth in order to provide a thorough understanding of the invention. However, the disclosure can be implemented in many other ways different from those described herein. Those skilled in the art can make similar improvements without violating the connotation of the disclosure. Therefore, the disclosure is not limited by the specific embodiments disclosed below.

In the description of the specification, the terms “first” and “second” are only used to distinguish different technical features, and cannot be understood as indicating or implying the relative importance or order of the indicated technical features. In the description of the disclosure, unless otherwise specifically defined, “multiple” means two or more.

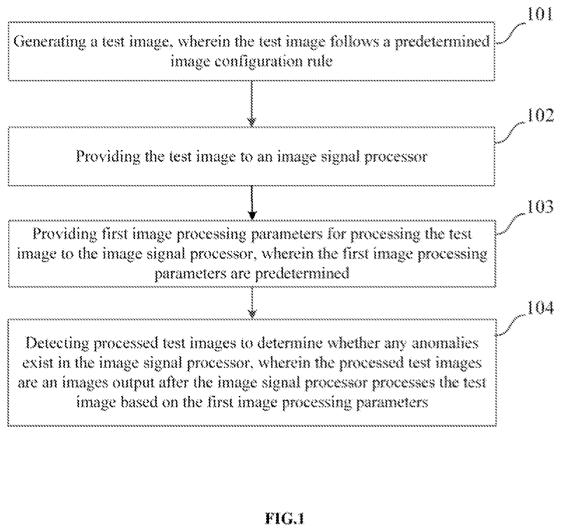

In one embodiment, the present disclosure provides a method for detecting anomaly of an image signal processor. As shown in FIG. 1, the method may include steps 101-104.

In step 101, a test image is generated, which follows a predetermined image configuration rules. The predetermined image configuration rules may include that, for example, the start of frame (SOF) flag of the image must be set before the end of frame (EOF) flag of the image, the horizontal size (Hsize) and vertical size (Vsize) of the image must be an integer multiple of 8 or 16, and the horizontal blank (Hblank) of the image must remain unchanged. Whether the horizontal size (Hsize) and vertical size (Vsize) of the image are an integer multiple of 8 or an integer multiple of 16 depends on the format of the test image to be generated (for example, JPEG image, etc.). In addition, generally, a frame image is composed of a line signal sequence with separate horizontal blanks. Therefore, for each frame image, the horizontal blanks of the image should remain unchanged before or after processing.

In one implementation example, in order to avoid the test logic error of the anomaly detection method itself due to some reasons, resulting in the test failure of the image signal processor, it is necessary to self detect the test logic of the anomaly detection method to ensure the correctness of the test function during each power-on reset, that is, before any normal image is provided to the image signal processor. Specifically, in this case, step 101 may include generating a test image based on predetermined image configuration parameters (i.e., at this time, the image configuration parameters are fixed and can be stored in a corresponding register) during the power-on reset of the image signal processor. Since the test image is fixed at this time and, as will be mentioned in step 103, the first image processing parameters for processing the test image are predetermined (i.e., fixed), the image which the image signal processor will output after processing the test image based on the first image processing parameters can be expected in advance. Further, for example, the cyclic redundancy check value of the output image can be expected, and then whether there is a logic error in the test logic of the anomaly detection method can be determined based on the expected cyclic redundancy check value. That is, in the present disclosure, the purpose of self-detection of the test logic of the anomaly detection method can be realized by providing a fixed test image and fixed first image processing parameters to the image signal processor during power-on reset.

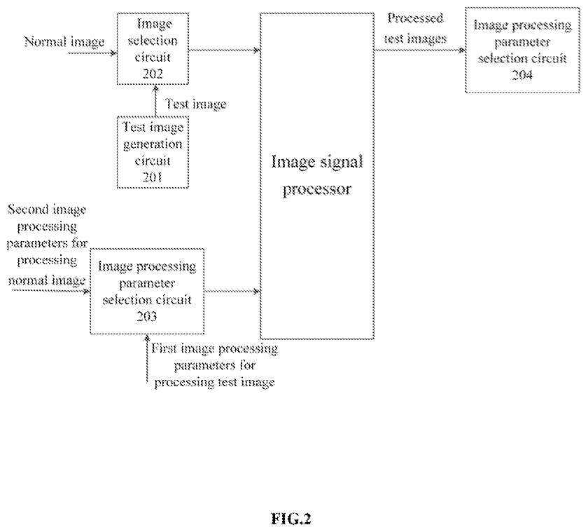

In another implementation example, in order to realize the real-time anomaly detection of the image signal processor, one frame of test image can be generated after each frame of normal image processing and before the next frame of normal image (E. G., generated by the test image generation circuit to be described later in connection with FIG. 2), and the test image is inserted between two normal input images and provided to the image signal processor for anomaly detection. Specifically, for any two consecutive normal input images, step 101 may include generating the test image based on the image configuration parameters when a first normal image has been processed by the image signal processor but a second normal image has not yet reached the image signal processor. The image configuration parameters are configured according to the predetermined image configuration rule and a time interval between an arrival time at which the first normal image reaches the image signal processor and an expected arrival time at which the second normal image reaches the image signal processor (e.g., configured by software). Since the image configuration parameters can be configured according to the actual situation, the flexibility and reliability of the anomaly detection can be improved from a certain angle. It should be understood that in the present disclosure, the images captured by the camera installed on the vehicle during unmanned driving and required to be processed by the image signal processor are called normal images, wherein the first normal image can indicate any normal image, and the second normal image can indicate the next normal image of the first normal image. The image configuration parameters may include the horizontal size and the vertical size of the test image, the positions of a start of frame flag and a end of frame flag of the test image, the horizontal blank of the processed test images, and the initial value associated with a data stream of the test image. In this case, the horizontal size, vertical size, the positions of a start of frame flag and an end of frame flag, horizontal blank and initial value mentioned above are configurable. Specifically, it can be configured according to the predetermined image configuration rule and a time interval between an arrival time at which the first normal image reaches the image signal processor and an expected arrival time at which the second normal image reaches the image signal processor. In practical applications, images are generally represented by data streams. In one implementation, the data streams of the test image can be obtained by accumulating the above-mentioned initial value with the preset step size. For example, when the initial value is set to 0 and the step size is set to 0x1, the data stream of the test image can be 0x0, 0x1, . . . , and the finally generated test image should also meet the above-mentioned image configuration rule. Generally speaking, for any specific application scenario, the time interval between any two normal images reaching the image signal processor is preset to be fixed. Therefore, for each application scenario, any test image inserted between any two normal images and provided to the image signal processor is the same. Therefore, it is not necessary to generate a test image between any two normal images, but only between the first normal image and the second normal image. The test image can be directly applied in the subsequent detection process.

Continuing with FIG. 1, in step 102, the test image is provided to the image signal processor. In one implementation, providing a test image to an image signal processor may include providing a test image to an image processing unit in the image signal processor.

In step 103, first image processing parameters for processing the test image are provided to the image signal processor, wherein the first image processing parameters are predetermined. In one implementation, the image processing involved in the first image processing parameters for processing the test image involves all image processing units in the image processing unit, so that the final anomaly detection result can accurately reflect the working condition of the whole image signal processor.

Specifically, when the step 101 specifically is generating a test image based on the predetermined image configuration parameters during the power-on reset of the image signal processor, step 103 may be directly providing the predetermined first image processing parameters to the image signal processor. The first image processing parameters may be stored in a corresponding register.

In addition, in the case the step 101 is generating the test image based on the image configuration parameters when a first normal image has been processed by the image signal processor but a second normal image has not yet reached the image signal processor, step 103 may include switching the image processing parameters of the image signal processor from second image processing parameters for processing the first normal image to the first image processing parameters. For example, the second image processing parameters for processing the first normal image and the first image processing parameters can be stored in different registers respectively, and the corresponding image processing parameters can be obtained from different registers as needed.

Returning to FIG. 1, in step 104, the processed test images are detected to determine whether there are anomalies in the image signal processor. The processed test images are the images output after the test image is processed by the image signal processor according to the first image processing parameters.

In one implementation, detecting the processed test images includes detecting the violation of the image configuration rule on the processed test images. The violation detection of the image configuration rule may include checking whether the processed test images violate the predetermined image configuration rule, and determining that the image signal processor has anomalies in a case where the processed test images violate the predetermined image configuration rule. For example, if the EOF flag of the processed test images is detected before the SOF flag, it indicates that the image signal processor is abnormal. As another example, if the vertical sizes or horizontal sizes of the processed test images are detected not being multiple of 8 or 16, it indicates that the image signal processor is also abnormal. For another example, if the horizontal blanks of the processed test images are found to be inconsistent with the horizontal blank of the test image, it indicates that the image signal processor is also abnormal, so the corresponding error indication signal can be output.

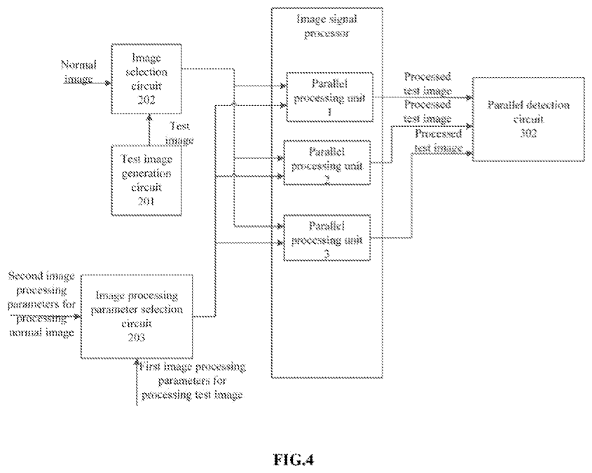

The image signal processor may generally include multiple parallel processing units (e.g., PreHDR processing units with different exposure US/V), and each processing unit shall realize the same processing function. Therefore, it is necessary to detect the functional consistency of these parallel processing units (e.g., see FIG. 4). Therefore, in another implementation, providing the test image to the image signal processor includes providing the test image to each parallel processing unit of the image signal processor, so the processed test images include multiple processed test images obtained after processing by each parallel processing unit. Thus, detecting the output images of the image signal processor includes parallel detection of the multiple processed test images. The parallel detection may include comparing the multiple processed test images, and determining that there are anomalies in the image signal processor when the multiple processed test images are inconsistent. Thus, the corresponding error indication signal can be output.

In another implementation, detecting the processed test images includes detecting the cyclic redundancy check value (CRC) of the processed test images. The CRC detection may include the following steps. A cyclic redundancy check value of the processed test images is calculated. The cyclic redundancy check value is compared with an expected cyclic redundancy check value. The expected cyclic redundancy check value is determined based on the test image and the first image processing parameters. And it is determined that anomalies exist in the image signal processor when the cyclic redundancy check value is inconsistent with the expected cyclic redundancy check value, so that the corresponding error indication signal can be output.

It is worth mentioning that the step of detecting the processed test images may include one or more of the above-mentioned image configuration rule violation detection, parallel detection and cyclic redundancy check value detection.

Based on the above error indication signal, the safety system of SOC chip can judge whether the image signal processor functions normally in real time, so as to avoid making wrong instructions due to the anomalies of image information during automatic driving, so as to avoid safety accidents.

In another embodiment, as shown in FIG. 2, an anomaly detection system for an image signal processor is provided. The anomaly detection system includes a test image generation circuit 201, an image selection circuit 202, an image processing parameter selection circuit 203 and an anomaly detection circuit 204. Since the anomaly detection system only needs to include the above circuits, it consumes less area resources.

The test image generation circuit 201 is configured to generate a test image that follows a predetermined image configuration rule. As mentioned above, the predetermined image configuration rule may include that, for example, the start of frame (SOF) flag of the image must be set before the end of frame (EOF) flag of the image, the horizontal size (Hsize) and vertical size (Vsize) of the image must be an integral multiple of 8 or 16, and the horizontal blank (Hblank) of the image must remain unchanged.

The image selection circuit 202 is configured to receive a normal image and the test image generated by the test image generation circuit, and is configured to select to provide the normal image or the test image to the image signal processor.

The image processing parameter selection circuit 203 is configured to receive first image processing parameters for processing the test image and second image processing parameters for processing the normal image, and is configured to select to provide the first image processing parameters or the second image processing parameters to the image signal processor, wherein the first image processing parameters is predetermined.

The anomaly detection circuit 204 is configured to receive the processed test images from the image signal processor, and is configured to detect the processed test images to determine whether any anomalies exist in the image signal processor, wherein the processed test images are images output by the image signal processor after processing the test image based on the first image processing parameters.

In one implementation example, in order to avoid the test logic error of the anomaly detection method itself due to some reason, resulting in the test failure of the image signal processor, it is necessary to self detect the test logic of the anomaly detection method to ensure the correctness of the test function during each power-on reset, that is, before any normal image is provided to the image signal processor. Specifically, in this case, the test image generation circuit 201 may be configured to generate a test image based on the predetermined image configuration parameters during the power-on reset of the image signal processor, and in this case, the image selection circuit 202 is configured to directly provide the generated test image to the image signal processor during the power-on reset of the image signal processor.

In another implementation example, in order to realize the real-time anomaly detection of the image signal processor, in the actual application process of the image signal processor, one frame of test image can be generated by the test image generation circuit 201 after each frame of normal image processing and before the next frame of normal image, and the test image is inserted between two normal input images and provided to the image signal processor for anomaly detection. Specifically, in this case, the test image generation circuit 201 may be configured to generate the test image based on the image configuration parameters when a first normal image has been processed by the image signal processor but a second normal image has not yet reached the image signal processor. The image configuration parameters are configured according to the predetermined image configuration rule and a time interval between an arrival time at which the first normal image reaches the image signal processor and an expected arrival time at which the second normal image reaches the image signal processor. Further, in this case, the image selection circuit 202 is configured to provide the test image to the image signal processor between the first normal image and the second normal image, and the image processing parameter selection circuit 203 is configured to switch the image processing parameters of the image signal processor from second image processing parameters for processing the first normal image to the first image processing parameters while the test image is provided to the image signal processor. In the present disclosure, the images captured by the camera installed on the vehicle during unmanned driving and required to be processed by the image signal processor are called normal images, wherein the first normal image can indicate any normal image, and the second normal image can indicate the next normal image of the first normal image. The image configuration parameters are the same as those mentioned in the above combined anomaly detection method, and will not be further described here.

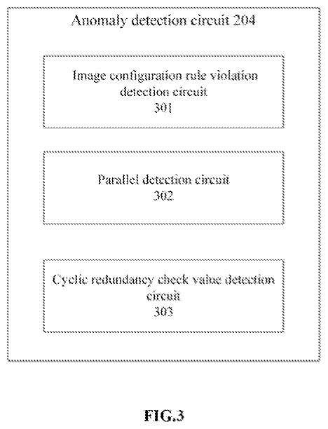

In one implementation, as shown in FIG. 3, the anomaly detection circuit 204 may include one or more of the image configuration rule violation detection circuit 301, the parallel detection circuit 302, and the cyclic redundancy check value detection circuit 303.

The image configuration rule violation detection circuit 301 is configured to check whether the processed test images violate the predetermined image configuration rule, and determine that the image signal processor has anomalies in a case where the processed test images violate the predetermined image configuration rule (for example, SRAM error/interference, or logic error caused by internal damage of the image signal processor, etc.), so that the corresponding error indication signal can be output. For example, if the EOF flag of the processed test image is detected before the SOF flag, it indicates that the image signal processor is abnormal. As another example, if the vertical size or horizontal size of the processed test images is detected not being a multiple of 8 or 16, it indicates that the image signal processor is also abnormal. For another example, if the horizontal blank of the processed test images is found inconsistent with the horizontal blank of the test image, it indicates that the image signal processor is also abnormal.

For example, as mentioned above, the image signal processor may generally include multiple parallel processing units (e.g., PreHDR processing units with different exposure L/SN), in which each processing unit shall realize the same processing function. Therefore, it is necessary to detect the functional consistency of these parallel processing units (for example, parallel processing unit 1, parallel processing unit 2 and parallel processing unit 3 as shown in FIG. 4). It is worth mentioning that although FIG. 4 shows three parallel processing units of the image signal processor with the same processing function, the image signal processor may have more or fewer parallel processing units, and may have multiple parallel processing units for different processing functions. In this case, the image selection circuit 202 is configured to provide the test image to each parallel processing unit (e.g., parallel processing unit 1, parallel processing unit 2 and parallel processing unit 3 as shown in FIG. 4), and the image processing parameter selection circuit 203 is configured to provide the first image processing parameters to each parallel processing unit. Therefore, the processed test images include multiple processed test images obtained after processing by each parallel processing unit. In this case, the parallel detection circuit 302 is configured to compare the plurality of processed test images, and determine that anomalies exist in the image signal processor when the plurality of processed test images are inconsistent (e.g., a logic error caused by an internal damage of a parallel processing unit, etc.). Thus, the corresponding error indication signal can be output.

The cyclic redundancy check value detection circuit 303 is configured to calculate the cyclic redundancy check value of the processed test images (this can be realized, for example, by a special cyclic redundancy check value generation circuit), compare the cyclic redundancy check value with an expected cyclic redundancy check value (which can be realized by a special comparator circuit, for example), wherein the expected cyclic redundancy check value is determined based on the test image and the first image processing parameters, and determine that anomalies exist in the image signal processor when the cyclic redundancy check value is inconsistent with the expected cyclic redundancy check value (for example, SRAM error/interference, or logic error caused by internal damage of the image signal processor, etc.). Thus, the corresponding error indication signal can be output.

Based on the above error indication signal, the safety system of SOC chip can judge whether the image signal processor works normally in real time, so as to avoid making wrong instructions due to the anomalies of image information during automatic driving, so as to avoid safety accidents.

What is claimed is:

1. A method for detecting anomaly of image signal processor, comprising:
generating a test image, wherein the test image follows a predetermined image configuration rule;
providing the test image to an image signal processor;
providing first image processing parameters for processing the test image to the image signal processor, wherein the first image processing parameters are predetermined; and
detecting processed test images to determine whether there are anomalies in the image signal processor;
wherein the processed test images are images output after the test image being processed by the image signal processor based on the first image processing parameters.

2. The method of claim 1, wherein the step of generating a test image comprises generating the test image based on predetermined image configuration parameters during a power-on reset of the image signal processor.

3. The method of claim 1, wherein the step of generating a test image comprises generating the test image based on the image configuration parameters when a first normal image has been processed by the image signal processor while a second normal image has not yet reached the image signal processor; wherein the image configuration parameters is configured according to the predetermined image configuration rule and a time interval between an arrival time at which the first normal image reaches the image signal processor and an expected arrival time at which the second normal image reaches the image signal processor; and
the step of providing first image processing parameter for processing the test image to the image signal processor comprises switching the image processing parameters of the image signal processor from second image processing parameters for processing the first normal image to the first image processing parameters.

4. The method of claim 2, wherein the image configuration parameters comprise a horizontal size and a vertical size of the test image, positions of a start of frame flag and a end of frame flag of the test image, a horizontal blank of the processed test images, and an initial value associated with a data stream of the test image.

5. The method of claim 1, wherein the step of detecting processed test images comprises:
checking whether the processed test images violate the predetermined image configuration rule, and determining that there are anomalies in the image signal processor in a case where the processed test images violate the predetermined image configuration rule.

6. The method of claim 1, wherein the predetermined image configuration rule comprises: the start of frame flag of the image being set before the end of frame flag of the image, the horizontal size and the vertical size of the image being an integer multiple of 8 or 16, and the horizontal blank of the image remaining unchanged.

7. The method of claim 1, wherein the image signal processor comprises a plurality of parallel processing units;
the step of providing the test image to an image signal processor comprises providing the test image to each parallel processing unit of the image signal processor:
the processed test images comprise a plurality of processed test images obtained after being processed via each parallel processing unit;
and the step of detecting processed test images comprises comparing the plurality of processed test images, and determining there are anomalies in the image signal processor when the plurality of processed test images are inconsistent.

8. The method of claim 1, wherein the step of detecting processed test images comprises:
calculating a cyclic redundancy check value of the processed test images;
comparing the cyclic redundancy check value with an expected cyclic redundancy check value, wherein the expected cyclic redundancy check value is determined based on the test image and the first image processing parameters; and
determining there are anomalies in the image signal processor when the cyclic redundancy check value is inconsistent with the expected cyclic redundancy check value.

9. An anomaly detection system for an image signal processor, comprising a test image generation circuit, an image selection circuit, an image processing parameter selection circuit and an anomaly detection circuit;
wherein the test image generation circuit is configured to generate a test image, and the test image follows a predetermined image configuration rule;
the image selection circuit is configured to receive a normal image and the test image generated by the test image generation circuit, and is configured to select to provide the normal image or the test image to the image signal processor;
the image processing parameter selection circuit is configured to receive first image processing parameters for processing the test image and second image processing parameters for processing the normal image, and is configured to select to provide the first image processing parameters or the second image processing parameters to the image signal processor, wherein the first image processing parameters is predetermined;
the anomaly detection circuit is configured to receive the processed test images from the image signal processor, and is configured to detect the processed test images to determine whether any anomalies exist in the image signal processor; wherein the processed test images are images output by the image signal processor after processing the test image based on the first image processing parameters.

10. The system of claim 9, wherein the test image generation circuit is configured to generate the test image based on predetermined image configuration parameters during power-on reset of the image signal processor, and the image selection circuit is configured to provide the generated test image to the image signal processor during a power-on reset of the image signal processor.

11. The system of claim 9, wherein
the test image generation circuit is configured to generate the test image based on the image configuration parameters when a first normal image has been processed by the image signal processor but a second normal image has not yet reached the image signal processor, wherein the image configuration parameters are configured according to the predetermined image configuration rule and a time interval between an arrival time at which the first normal image reaches the image signal processor and an expected arrival time at which the second normal image reaches the image signal processor;
the image selection circuit is configured to provide the test image to the image signal processor between the first normal image and the second normal image; and
the image processing parameter selection circuit is configured to switch the image processing parameters of the image signal processor from second image processing parameters for processing the first normal image to the first image processing parameters while the test image is provided to the image signal processor.

12. The system of claim 9, wherein the anomaly detection circuit comprises an image configuration rule violation detection circuit, and the image configuration rule violation detection circuit is configured to check whether the processed test images violate the predetermined image configuration rule, and determine that there are anomalies in the image signal processor in a case where the processed test images violate the predetermined image configuration rule.

13. The system of claim 9, wherein the predetermined image configuration rule comprises: the start of frame flag of the image being set before the end of frame flag of the image, the horizontal size and the vertical size of the image being an integer multiple of 8 or 16, and a horizontal blank of the image remaining unchanged.

14. The system of claim 9, wherein
the image signal processor comprises a plurality of parallel processing units:
the image selection circuit is configured to provide the test image to each parallel processing unit;
the image processing parameter selection circuit is configured to provide the first image processing parameters to each parallel processing unit;
the processed test images comprise a plurality of processed test images respectively obtained after being processed via each parallel processing unit; and
the anomaly detection circuit comprises parallel detection circuit, and the parallel detection circuit are configured to compare the plurality of processed test images, and determine that anomalies exist in the image signal processor when the plurality of processed test images are inconsistent.

15. The system of claim 9, wherein the anomaly detection circuit comprises a cyclic redundancy check value detection circuit, and the cyclic redundancy check value detection circuit is configured to: calculate a cyclic redundancy check value of the processed test image; compare the cyclic redundancy check value with an expected cyclic redundancy check value, wherein the expected cyclic redundancy check value is determined based on the test image and the first image processing parameters; and determine that anomalies exist in the image signal processor when the cyclic redundancy check value is inconsistent with the expected cyclic redundancy check value.
